(19) United States
(12) Patent Application Publication
(10) Pub. No.: US 2019/0016635 A1
(43) Pub. Date: Jan. 17, 2019

(54) FLUIDIZING MIX FOR A COMPOSITION WITH A BASE OF HYDRAULIC BINDER

(71) Applicant: HOLCIM TECHNOLOGY LTD, JONA (CH)

(72) Inventors: David RINALDI, LYON (FR); Emmanuel VILLARD, SAINT-CHRISTO-EN-JAREZ (FR); Stéphane VENON, SAINT AIGNAN LE JAILLARD (FR); Denis ROCCA, VILLEURBANNE (FR)

(21) Appl. No.: 16/047,656

(22) Filed: Jul. 27, 2018

Related U.S. Application Data
(63) Continuation of application No. 13/388,567, filed on Feb. 2, 2012, now abandoned.

(30) Foreign Application Priority Data
Aug. 5, 2009 (FR) 09/03861

(51) Int. Cl. C04B 24/00; C04B 28/02; C04B 40/00; C04B 24/24; C04B 24/26; C04B 103/00

(52) U.S. Cl. CPC C04B 24/003; C04B 28/02; C04B 2103/006; C04B 24/243; C04B 24/2647; C04B 40/0039

(57) ABSTRACT

The present invention relates to a hydraulic composition comprising:
at least one hydraulic binder;
at least one first water-reducing additive comprising at least one phosphonic amino-alkylene group;
at least one second water-reducing additive comprising at least one polymer with a comb structure, the concentration by weight of dry extract of the second additive being from 25% to 100% of the concentration by weight of dry extract of the first additive.

A concrete comprising such a hydraulic composition and a fluidizing mix for such a hydraulic composition are two other aspects of the present invention.

### CROSS-REFERENCE TO RELATED APPLICATIONS

This application is a continuation of U.S. application Ser. No. 13/388,567, filed on Feb. 2, 2012, which is the U.S. National Stage of PCT/FR2010/051641, filed Aug. 2, 2010, which in turn claims priority to French Patent Application No. 09/03861, filed Aug. 5, 2009, the entire contents of all applications are incorporated herein by reference in their entireties.

The present invention relates to compositions with a base of hydraulic binder used for the production of parts and structures in concrete. More particularly, the present invention relates to compositions with a base of hydraulic binder in which at least one water-reducing agent is mixed. It is, for example a concrete which comprises a hydraulic binder mixed with fine aggregates, for example sand, and optionally coarse aggregates, for example ground stone.

When the components of the concrete are mixed with water, a composition is obtained which sets and hardens as a result of hydration reactions and processes, and which after hardening, keeps its strength and its stability even under water. Before setting, the concrete is workable for a limited period of time, generally called the workability window. The workability window may be defined as being the length of time during which the spread or the slump of the cement composition is greater than a given value.

A problem to be taken into account during the production of concrete corresponds to the quantity of mixing water to be used. The quantity of mixing water should be sufficient to be able to suitably handle the concrete. However, an increase of the quantity of mixing water tends to reduce the compressive strength of the obtained concrete after hardening.

The concrete may comprise one or more additives, called fluidizers or water-reducing agents to obtain a concrete having satisfactory fluidity during the workability window without using an excessive quantity of water.

Examples of water-reducing agents correspond to the compounds described in patent EP 0 663 892 filed in the name of Chryso. They are compounds comprising a poly oxyalkyl chain and a phosphonic amino-alkylene group. Even though these additives make it possible to efficiently reduce the viscosity of a concrete, the dosage of these additives in the concrete may be important to obtain the desired effects. This may become a drawback insofar as the production cost of these additives is high. Furthermore, these additives could induce a setting delay which increases with the dosage of the additive.

The aim of the present invention is to provide a composition with a base of hydraulic binder which has a workability window of at least 90 minutes, which has reduced viscosity in the workability window and for which the setting time is not too high.

With this aim the present invention provides a hydraulic composition comprising:
at least one hydraulic binder;
at least one first water-reducing additive comprising at least one phosphonic amino-alkylene group;
at least one second water-reducing additive comprising at least one polymer with a comb structure, the concentration by weight of dry extract of the second additive being from 25% to 100% of the concentration by weight of dry extract of the first additive.

Advantageously, the dosage of the first additive in the composition according to the present invention is less than the dosage which should be used to obtain a same initial spread or slump if the first additive were used alone. The production cost of the hydraulic composition is thus reduced. The present invention makes it possible to simultaneously obtain:
a slump similar to the one which would be obtained in the case where only the first additive had been used;
a dosage of the fluidizing mix in the hydraulic composition clearly less (in particular by more than 50%) than what would be obtained in the case where only the first additive had been used;
a setting delay clearly less (in particular by more than 50%) than the setting delay which would be obtained in the case where only the first additive had been used; and
a viscosity clearly less (in particular by more than 15%) than the one which would be obtained in the case where only the first additive had been used.

The expression «hydraulic binder» is to be understood according to the present invention as a pulverulent material, which, mixed with water, forms a paste which sets and hardens as a result of hydration reactions and processes, and which, after hardening, keeps its strength and its stability, even under water. The expression «hydraulic composition» is to be understood as any composition comprising a hydraulic binder. It is, for example a concrete.

The term «concrete», is to be understood as a mix of hydraulic binder, aggregates, water, optionally additives, and optionally mineral additions, for example high performance concrete, very high performance concrete, self-placing concrete, self-levelling concrete, self-compacting concrete, fibre concrete, ready-mix concrete or coloured concrete. The term «concrete», is also to be understood as concretes having been submitted to a finishing operation, for example bush-hammered concrete, exposed or washed concrete or polished concrete. Pre-stressed concrete is also to be understood by this definition. The term «concrete» comprises mortars, in this specific case the concrete comprises a mix of hydraulic binder, sand, water and optionally additives and optionally mineral additions. The term «concrete» according to the invention denotes indistinctly fresh concrete or hardened concrete.

The term «aggregates» is to be understood according to the invention as gravel, coarse aggregates and/or sand.

The expression «mineral additions» is to be understood according to the invention as a finely divided mineral material used in concrete in order to improve certain properties or to give it particular properties. Examples of mineral additions are fly ash (as defined in the EN 450 Standard), silica fume (as defined in the prEN 13263 Standard: 1998 or the NF P 18-502 Standard), slags (as defined in the NF P 18-516 Standard), limestone additions (as defined in the NF P 18-508 Standard) and siliceous additions (as defined in the NF P 18-509 Standard).

The term «setting», is to be understood according to the present invention as the passage to the solid state by chemical hydration reaction of the binder. The setting is generally followed by a hardening period.

The term «hardening», is to be understood according to the present invention as the development of mechanical properties of a hydraulic binder, after the end of the setting.

The expression «water-reducing agent», is to be understood as an additive which is used to reduce the quantity of water necessary to produce a concrete by at least 5%. By way of example, the water-reducing agents with a base of lignosulfonic acids, carboxylic oxacids or treated carbon hydrates can reduce by approximately 10% to 15% water requirements to produce a concrete.

The expression «superplasticizer» or «superfluidizer» or «super water-reducing agent», is to be understood as a water-reducing agent which makes it possible to reduce by more than 12% the quantity of water required to produce a concrete. The superplasticizers have been broadly classified into four groups: sulphonated naphtalene formaldehyde condensate, (or SNF); sulphonated melamine formaldehyde condensate, (or SMF); modified lignosulfonates (or MLS); and others. More recent superplasticizers comprise dispersing compounds of the polycarboxylate polymer type («PC»). Certain PC superplasticizers may have a comb structure comprising at least one main chain and side chains. Such superplasticizers are designated by the general acronym, PCP. For example, these superplasticizers carry ionic functions of the carboxylic and/or sulfonic and/or phosphonic type, preferably the carboxylic type at the level of the main chain and side chains of polyethylene glycol, polypropylene glycol, copolymers of ethylene and propylene glycol or other chains that are preferably water soluble.

The expression «alkylene polyoxide polycarboxylate», is to be understood as comb copolymers in the main chain carrying grafted side chains of alkylene polyoxide.

The expression «ester content» of a polymer, is to be understood as the proportion of monomer units of the main chain carrying an ester function defined by the formula herein below:

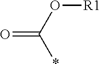

where R1 represents a group carrying at least one carbon atom by which it is linked to the oxygen atom of the ester function and * is the symbol of the main chain. R1 can in particular be an alkyl group or a graft of alkylene polyoxide. The level of ester is expressed by molar percentage and it is calculated by dividing the number of ester functions on the main chain by the total number of monomer units on the main chain.

By way of example, the hydraulic binder may be a Portland cement. It may be a cement of type CEM I, CEM II, CEM III, CEM IV or CEM V according to the NF EN 197-1 «Cement» Standard.

According to an example of embodiment, the concentration by weight of dry extract of the second additive is strictly greater than 25% and strictly less than 100%, preferably comprised from 26% to 99%, most preferably comprised from 30% to 95%, of the concentration by weight of dry extract of the first additive.

The second additive is a water-reducing agent which makes it possible to reduce by more than 12% the quantity of water required to produce a concrete. According to an example of embodiment, the second additive is a water-reducing agent of the polycarboxylate polymer or PC type. By way of example, the second additive is obtained for example, by copolymerisation of monomers of polyoxy alkylene (meth)acrylate and monomers of carboxylic acid, and optionally other monomers which are copolymerised with these monomers.

The second additive may correspond to a PCP and have a comb structure comprising at least one main chain and side chains. The second additive may be a polymer of the polyoxy alkylene polycarboxylate type. According to an example of embodiment of the present invention, the second additive corresponds to the CHRYSO Fluid Optima 206 additive commercialised by Chryso. According to another example of embodiment of the present invention, the second additive is a polycarboxylate of polyoxyalkylene of methacrylic nature.

An example of a process for production of a methacrylic polymer, a polycarboxylate of polyoxyalkylene of methacrylic nature, which can be used as a second additive is now described.

The following components are successively introduced into a 500 ml 3-neck flask:
86.8 g of methylmethacrylate polyethylene glycol (MMPEG) having a molecular weight of 1100 daltons;
13.1 g of methacrylic acid; and
150 g of tetrahydrofuran (THF).

The flask is equipped with a temperature probe, a nitrogen inlet to carry out degassing of the solution contained in the flask and a cooling system to condense possible released vapours.

After starting up the water circulation in the cooling circuit and the nitrogen degassing, stirring is begun as well as heating of the reaction medium to a set temperature of 60° C. Once the set temperature is reached and the reaction medium is sufficiently degassed (approximately 20 minutes), 0.42 g of thioglycolic acid is added into the flask. Two minutes later, 0.59 g of Vazo™ 52 are added (thermal initiator commercialised by DuPont). This operation is used as the reference time. The reaction medium is kept at this set temperature for 6 hours. The heating is then stopped and the medium is left to cool. Once at ambient temperature, water is added to the medium and the THF is evacuated by rotating evaporation. Thus an aqueous solution of polymer is recovered which can be used as second additive according to an example of embodiment of the present invention.

According to an example of embodiment, the first additive corresponds to the CHRYSO Fluid Optima 100 additive commercialised by Chryso.

According to an example of embodiment, the first additive corresponds to the following Formula (1):

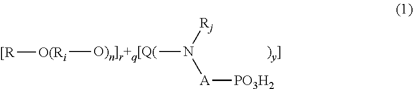

in which:
R is a hydrogen atom or a monovalent hydrocarbon group with 1 to 18 carbon atoms and optionally one or more hetero atoms;
the Rᵢ are similar or different and represent an alkylene for example ethylene, propylene, amylene, octylene or cyclohexene or an arylene, for example styrene or methylstyrene, the Rᵢ optionally comprising one or more hetero atoms;
Q is a hydrocarbon group with 2 to 18 carbon atoms and optionally one or more hetero atoms;
A is an alkylidene group with 1 to 5 carbon atoms;
the Rⱼ are similar or different and may be selected from:
   the A-P0₃H₂ group, A having the aforesaid meaning;
   an alkyl group with 1 to 18 carbon atoms and being able to carry [R—O(Rᵢ—O)ₙ] groups, R and Rᵢ having the aforesaid meanings;
   and the group:

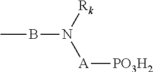

Rₖ designating a group such as Rⱼ;
B designating an alkylene group carrying 2 to 18 carbon atoms;
“n” is a number greater than or equal to 0;
“r” is the sum of the [R—O(Rᵢ—O)ₙ] groups carried by all the R;
“q” is the number of [R—O(Rᵢ—O)ₙ] groups carried by Q;
the sum “r+q” is from 1 to 10;
“y” is an integer from 1 to 3;
Q, N and the Rⱼ can form together one or more cycles, this or these cycles further being able to contain one or more other hetero atoms.

The compounds or the salts of the compounds according to Formula (1) may be used. The salts of the compounds according to formula (1) may be stœchiometric or not, mixed or not, and are constituted with alkali metals, alkali earth metals, amines or quaternary ammoniums.

An example of a process for preparation of the compounds of Formula (1) is described in European Patent Application 0 663 892.

According to the invention, the preferred compounds of Formula (1) are used, where R is a hydrogen atom or a methyl, ethyl or nonylphnol group. More preferably, R is a hydrogen atom.

The Rᵢ groups are preferably selected from ethylene and propylene. It is even more preferable that the majority or all of the Rᵢ groups are ethylene, and be in a sufficient number to maintain the water-soluble or water-dispersing character of the compounds according to Formula (1).

The Q group preferably carries 2 to 12 carbon atoms, and more preferably it carries 2 to 6 carbon atoms. Advantageously, Q is selected from ethylene, cyclohexene or n-hexene.

The alkylidene A group, which carries a divalent carbon atom preferably carries 1 to 3 carbon atoms. It is particularly advantageous that A be the methylene group.

The Rⱼ group, which is optionally in salt form, is preferably selected from the —CH₂—PO₃H₂, methyl and C₂H₄N(CH₂PO₃H₂)₂ groups More preferably Rⱼ represents the —CH₂—PO₃H₂ group.

It is desirable that “n” be between 1 and 10 000. The values of “n” between 1 and 500 are particularly preferred. Ideally, a value is selected for “n” which is between 1 and 250.

The sum “r+q” corresponds to the total number of polyoxyalkyl chains. Preferably this sum is less than 3. More preferably it is equal to 1.

When they are in the state of salt, the compounds according to Formula (1) are preferably sodium, calcium or diethanolamine salts.

The processes for production of two more specific examples of a first additive corresponding to the general Formula (1) are described herein below.

The first example of the first additive corresponds to the following Formula (2):

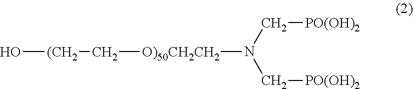

The first example of the first additive is made from a typical intermediary compound corresponding to the following Formula (3):

HO—(CH₂CH₂O)₅₀—CH₂CH₂—NH₂ (3)

The following elements are introduced into a one-litre 3-neck flask equipped with a cooling device: 226 g of the compound according to Formula (3), 16.4 g of crystallised phosphorous acid and 12 g of hydrochloric acid in aqueous solution at 35%.

The mix is heated under agitation up to 10° C., then, 17.8 g of an aqueous solution of formaldehyde at 37% is introduced in five hours and is heated to reflux for seventeen hours.

The reaction medium is then poured into 900 cm³ of cold water, and the content of dry matter is adjusted to 30% by dilution.

According to an example of embodiment, the first additive corresponds to following Formula (4):

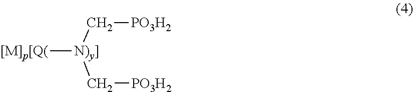

in which:
M is a linear or branched hydrocarbon group (optionally in dendrimers) optionally comprising one or more hetero atoms (O, N, S); optionally of different natures;
Q is a hydrocarbon group with 2 to 18 carbon atoms and optionally one or more hetero atoms;
“p” is the number of groups [M] carried by Q, p being comprised from 1 to 10; and
“y” is an integer comprised from 1 to 3.

The M group of which there are p in total may be identical or different. Preferably, the M group does not comprise a phosphate group. Each M group may have a molar mass greater than 1000 g/mol. The molar mass of all the M groups of a same molecule is preferably comprised from 2000 to 10000 g/mol.

Preferably, the number p is less than twice the number y.

Examples of embodiments will now be described with reference to the figures, of which:

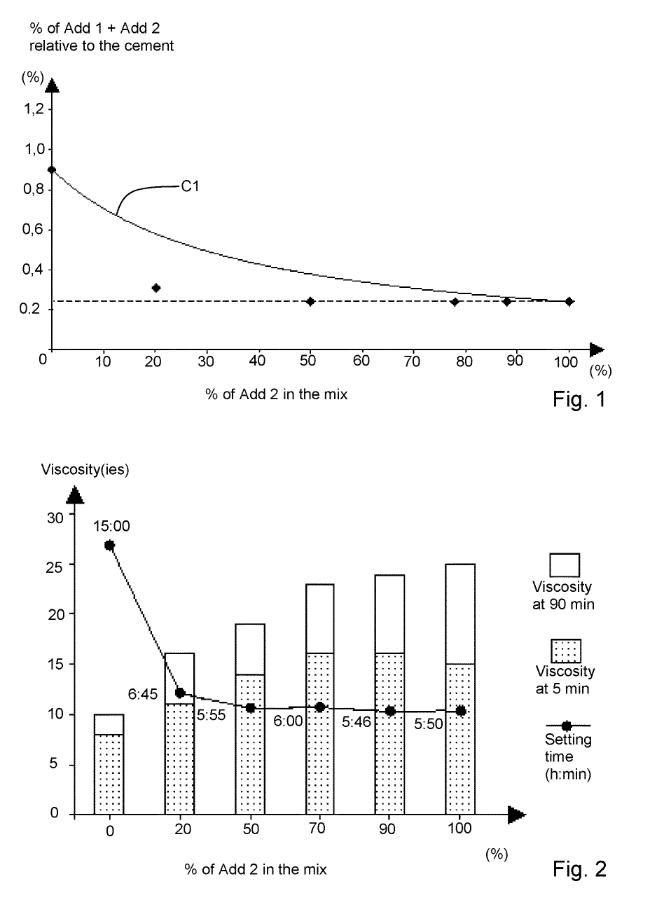

FIG. 1 represents the theoretical and real evolutions of the dosage of a fluidizing mix in a hydraulic composition relative to the percentage of the second additive in the fluidizing mix to obtain a given initial spread; and

FIG. 2 represents the evolutions of the viscosity and the setting time of the hydraulic composition corresponding to FIG. 1 relative to the percentage of the second additive in the fluidizing mix.

### METHOD TO MEASURE THE SPREAD OF A HYDRAULIC COMPOSITION

The principle of the spread measurement consists in filling a truncated spread measurement cone with the hydraulic composition to be tested, then releasing the said composition from the said truncated spread measurement cone in order to determine the surface of the obtained disk when the hydraulic composition has finished spreading. The truncated spread measurement cone corresponds to a reproduction at the scale ½ of the cone as defined by the NF P 18-451 Standard, 1981. The truncated spread measurement cone has the following dimensions:
top diameter: 50+/−0.5 mm;
bottom diameter: 100+/−0.5 mm; and
height: 150+/−0.5 mm.

The entire operation is carried out at 20° C. The spread measurement is carried out in the following manner:
Fill the reference cone in one single time with the hydraulic composition to be tested;
If necessary, tap the hydraulic composition to homogenously distribute it in the truncated cone;
Level the top surface of the cone;
Lift the truncated cone vertically; and
Measure the spread according to four diameters at 45° with a caliper square. The result of the spread measurement is the average of the four values, +1-1 mm.

### METHOD TO MEASURE THE VISCOSITY OF A HYDRAULIC COMPOSITION

The viscosity measurement consists in measuring the flow time through a truncated viscosity measurement cone of a hydraulic composition to be tested. The truncated viscosity measurement cone has the following dimensions:
larger diameter: 150 mm; and
smaller diameter: 17 mm.

The truncated viscosity measurement cone further comprises first and second marks which may be parallel marks provided on the sides of the truncated cone and defining planes perpendicular to the axis of the truncated cone. The first mark is closer to the base of the larger diameter than the second mark. The distance between the two marks is 60 mm, the first mark being at 12 mm from the base with the larger diameter.

The entire operation is carried out at 20° C. The viscosity measurement of a hydraulic composition is carried out in the following manner:
Orient the axis of the truncated cone vertically, the smaller diameter being oriented downwards and being obturated by a plug;
Fill the truncated cone with the hydraulic composition up to above the first mark;
Tap the hydraulic composition with a spatula in order to ensure the absence of big air bubbles;
Remove the plug;
Start the stopwatch when the level of hydraulic composition passes the first mark;
Stop the stop watch when the level of hydraulic composition passes the second mark; and
Record the time, which represents the viscosity of the hydraulic composition.

### METHOD TO MEASURE THE SETTING START AND SETTING END TIMES OF A MORTAR

This method is based on the standardized measurement method for determination of the setting time and stability according to the EN 196-3 Standard. It uses an automatic VICAT setting meter as described in the EN 196-3 Standard, a truncated cone and a container. The VICAT setting meter comprises a needle, a plate and a movement mechanism of the needle relative to the plate along the vertical axis. The needle can have the shape of a straight cylinder having a length greater than 45 mm and a diameter of approximately 1.13 mm. The axis of the needle is vertical. The container has bigger dimensions than the mould and is placed on the plate. The mould has a truncated shape. The mould is placed in the container, the axis of the mould coinciding with the rotation axis of the plate.

The entire operation is carried out at 20° C. The method to measure the setting start and setting end times of the mortar is the following:
Oil the truncated mould using a brush and demoulding oil;
Place this mould into the container;
Fill the mould with mortar;
Level the surface of the mould using a ruler to obtain a flat surface;
Place the mould+container assembly on the plate;
Add an additional mass of 700 g to the needle support;
Move the needle in the mortar, the time between each lowering of the needle being 10 minutes, the movement of the needle corresponding to a free drop from the free surface of the mortar. This operation is repeated 90 times.

The setting start time corresponds to the time after which the needle falls to only 4 mm±1 mm from the bottom of the mould. The time is measured from the moment TO of the method for preparation of the mortar described herein after. The setting end time corresponds to the time after which the needle falls only to 0.5 mm in the mortar. The time is measured from the moment TO of the method for preparation of the mortar described herein after.

### METHOD FOR PREPARATION OF THE MORTAR

The mortar is made using a Perrier type of mixer. The entire operation is carried out at 20° C. The preparation method comprises the following steps:
Put the sands in a mixer bowl;
At T=0 second: start the mixing at low speed (140 rpm) and simultaneously add the wetting water in 30 seconds, then continue to mix at low speed (140 rpm) until 60 seconds;
At T=1 minute: stop the mixing and let rest for 4 minutes;
At T=5 minutes: (TO for the measurement method of the setting time): add the hydraulic binder;
At T=6 minutes: mix at low speed (140 rpm) for 1 minute;
At T=7 minutes: add the mixing water (+first and second additives) in 30 seconds (whilst mixing at low speed (140 rpm)); and
At T=7 minutes and 30 seconds: mix at high speed (280 rpm) for 2 minutes.

### Mortar Formulations

Two mortar formulations were used to carry out these tests.

TABLE 1
Mortar Formulation 1

| Component | Mass (g) |
|---|---|
| Cement | 480.4 |
| ISO sand | 1350 |
| Siliceous sand | 200.1 |
| Limestone filler | 354.1 |
| Total water, of which: | 326.7 |
| mixing water | 226.7 |
| sand wetting water | 100 |
| Water/Cement ratio | 0.68 |

TABLE 2
Mortar Formulation 2

| Component | Mass (g) |
|---|---|
| Cement | 480.4 |
| ISO sand | 1350 |
| Fine sand | 200.1 |
| Limestone filler | 340.8 |
| Total water, of which: | 297.8 |
| mixing water | 197.8 |
| sand wetting water | 100 |
| Water/Cement ratio | 0.62 |

The cement is a Portland cement of the CEM I 52.5 N type produced at the Lafarge Saint-Pierre-La-Cour cement plant.

The ISO sand is a certified CEN EN 196-1 sand (Supplier: Société Nouvelle de Littoral). It is a natural siliceous sand, with rounded grains, with a content of silica at least equal to 98%. Its grading composition is within the bounds given in Table 3.

TABLE 3
Grading composition of the ISO sand

| Dimensions of the | Cumulated oversize |
|---|---|
| squared mesh (mm) | on the sieves (%) |
| 2.00 | 0 |
| 1.60 | 7 ± 5 |
| 1.00 | 33 ± 5 |
| 0.50 | 67 ± 5 |
| 0.16 | 87 ± 5 |
| 0.08 | 99 ± 1 |

The limestone filler is the Erbray Filler (Supplier: MEAC). The siliceous sand is the Fulchiron PE2 LS sand (Supplier: Fulchiron).

Certain properties of a mortar made according to formulation 1 or 2, and comprising a mix of first and second additives for different dosages of the first and second additives were compared in the following examples. The first additive is called Add 1 and corresponds to CHRYSO Fluid Optima 100 (Supplier: Chryso) in the following examples. CHRYSO Fluid Optima 100 is an additive in the family of diphosphonates and the formula of which is similar to formula (2). The second additive is called Add 2 and corresponds to a polymer of the de polyalkylene oxide polycarboxylate type. The concentrations or dosages of the first and second additives are given by weight relative to the weight of the cement. For each mortar, according to the measurement methods described herein above the following elements were measured:
the setting start time;
the spread of the mortar at successive time periods; and
the viscosity of the mortar at successive time periods.

### EXAMPLE 1

A mortar corresponding to formulation 2 was made. The additive Add 2 was CHRYSO Fluid Optima 206 (supplier: Chryso). Three examples of concentrations of additives Add 1 and Add 2 were tested. The obtained results are grouped together in Table 4 herein below:

TABLE 4

| Optima 100/ | Dosage | | | | | |
|---|---|---|---|---|---|---|
| Optima 206 | Total | Dosage | Dosage | Rheology (mm) | Viscosity(ies) | Setting |
| (%) | dosage | Add 1 | Add 2 | at 5 min | at 5 min | start time |
| 100/0 | 0.9% | 0.9% | 0.0% | 305 | 14 | >12 h |
| 50/50 | 0.34% | 0.17% | 0.17% | 345 | 24 | 5 h 45 min |
| 0/100 | 0.32% | 0.00% | 0.32% | 315 | 35 | 4 h 50 min |

The dosage of the additive Add 1 alone, (referred to as “dosage_Add_1”) corresponds to a given initial spread. The dosage of the additive Add 2 alone, (referred to as“dosage_Add_2”) corresponds to the same initial spread for this product. The theoretical dosage, “dosage_mix” of the mix corresponding to the same initial spread and comprising a percentage “w % Add_1” by weight of the additive Add 1 and a percentage “w % Add_2” by weight of the additive Add 2 can be given by the law of mixes according to the following relation:

$$\frac{1}{dosage\_mix} = \frac{w \% Add\_ 1}{dosage\_Add \_ 1} + \frac{w \% Add\_ 2}{dosage\_Add \_ 2}$$

In the present example, the theoretical dosage of the fluidizing mix comprising 50% by weight of the additive Add 1 and 50% by weight of the additive Add 2 would be 0.49% by weight relative to the weight of the cement to obtain an initial spread of the order of 320 mm. The real obtained dosage was 0.34% by weight relative to the weight of the cement. The Applicant therefore showed that, surprisingly, the real dosage of a mix comprising 50% by weight of the additive Add 1 and 50% by weight of the additive Add 2 to obtain a given initial spread is less than the expected theoretical dosage. Furthermore, the initial viscosity (at 5 minutes) of the mortar comprising the additives Add 1 and Add 2 was, advantageously, less than the initial viscosity of the mortar only comprising the additive Add 2. Furthermore, the setting start time of the mortar comprising the additives Add 1 and Add 2 was, advantageously, clearly lower than the setting start time of the mortar only comprising the additive Add 1 and only slightly higher than the setting start time of the mortar only comprising the additive Add 2.

### EXAMPLE 2

A mortar corresponding to formulation 1 was made. The additive Add 2 was CHRYSO Fluid Optima 206 (supplier: Chryso). Three examples of concentrations of additives Add 1 and Add 2 were tested. The obtained results are grouped together in Table 5 herein below:

TABLE 5

| Optima 100/ | Dosage | | | | | |
|---|---|---|---|---|---|---|
| Optima 206 | Total | Dosage | Dosage | Rheology (mm) | Viscosity(ies) | Setting |
| (%) | dosage | Add 1 | Add 2 | at 5 min | at 5 min | start time |
| 100/0 | 0.75% | 0.75% | 0.00% | 320 | 8 | >15 h |
| 50/50 | 0.24% | 0.12% | 0.12% | 330 | 13 | 5 h 45 min |
| 0/100 | 0.24% | 0.0% | 0.24% | 340 | 18 | 5 h 30 min |

In the present example, the theoretical dosage of the fluidizing mix comprising 50% by weight of the additive Add 1 and 50% by weight of the additive Add 2 would be 0.36% by weight relative to the weight of the cement to obtain an initial spread of the order of 330 mm. The real obtained dosage was 0.24% by weight relative to the weight of the cement. The Applicant therefore showed that, surprisingly, the real dosage of a mix comprising 50% by weight of the additive Add_1 and 50% by weight of the additive Add_2 to obtain a given initial spread is less than the expected theoretical dosage. Furthermore, the initial viscosity (at 5 minutes) of the mortar comprising the additives Add 1 and Add 2 was, advantageously, less than the initial viscosity of the mortar only comprising the additive Add 2. Furthermore, the setting start time of the mortar comprising the additives Add 1 and Add 2 was, advantageously, clearly lower than the setting start time of the mortar only comprising the additive Add 1 and was of the same order as the setting start time of the mortar only comprising the additive Add 2.

### EXAMPLE 3

A mortar corresponding to formulation 1 was made. The additive Add 2 was the methacrylic PCP. Six examples of concentrations of the additives Add 1 and Add 2 were tested. The obtained results are grouped together in Table 6 herein below and illustrated in FIGS. 1 and 2:

TABLE 6

| Optima 100/ | Dosage | | | | | |
|---|---|---|---|---|---|---|
| PCP | Total | Dosage | Dosage | Rheology (mm) | Viscosity(ies) | Setting |
| (%) | dosage | Add 1 | Add 2 | at 5 min | at 5 min | start time |
| 100/0 | 0.75% | 0.75% | 0.00% | 320 | 8 | >15 h |
| 80/20 | 0.30% | 0.24% | 0.06% | 340 | 11 | 6 h 45 min |
| 50/50 | 0.24% | 0.12% | 0.12% | 345 | 14 | 5 h 55 min |
| 30/70 | 0.24% | 0.05% | 0.19% | 335 | 16 | 6 h 00 min |
| 10/90 | 0.24% | 0.03% | 0.21% | 335 | 16 | 5 h 46 min |
| 0/100 | 0.24% | 0.00% | 0.24% | 340 | 15 | 5 h 50 min |

In FIG. 1, the curve C1 represents the theoretical evolution of the dosage of the fluidizing mix in the mortar relative to the percentage of the second additive in the fluidizing mix in order to obtain a given initial spread of approximately 330 mm. Curve C1 was obtained from the mixing law described herein above. In the present example, surprisingly, the real dosage of the fluidizing mix was less than the theoretical dosage of the composition to obtain an initial spread of the order of 330 mm. Furthermore, at least until reaching a percentage of the first additive less than 75% by weight in the fluidizing mix, the dosage of the fluidizing mix only very slightly increased relative to the dosage of the fluidizing mix comprising 100% by weight of the second additive. Furthermore, for a dispersing composition comprising at least 50% by weight of the additive Add 1, the viscosity of the mortar comprising the additives Add 1 and Add 2 was, advantageously, close to the viscosity of the mortar only comprising the additive Add 1 and was lower than the initial viscosity of the mortar only comprising the additive Add 2. Furthermore, the setting start time of the mortar comprising the additives Add 1 and Add 2 was, advantageously, clearly lower than the setting start time of the mortar only comprising the additive Add 1 and was only higher by approximately one hour (for a dispersing composition comprising 80% by weight of the additive Add 1) relative to the setting start time of the mortar only comprising the additive Add 2.

Therefore, when the concentration by weight of dry extract of the second additive is from 25% to 100% of the concentration by weight of dry extract of the first additive, simultaneously the following results are obtained:
a slump similar to the one which would be obtained in the case where only the first additive had been used;
a dosage of the fluidizing mix in the hydraulic composition less by more than 50% than what would be obtained in the case where only the first additive had been used;
a setting delay less by more than 50% than the setting delay which would be obtained in the case where only the first additive had been used; and
a viscosity less by more than 15% than what would be obtained in the case where only the first additive had been used.

1.-14. (canceled)

15. A method to reduce the setting start time of a hydraulic composition comprising at least one hydraulic binder and at least one first water-reducing additive comprising at least one phosphonic amino-alkylene group, the method comprising adding at least one second water-reducing additive comprising at least one polycarboxylate of polyoxyalkylene of methacrylic acid with a comb structure to the hydraulic composition and the concentration by weight of dry extract of the second water-reducing additive being in a range from 30% to 95% of the concentration by weight of dry extract of the first water-reducing additive.

16. The method according to claim 15, wherein the concentration by weight of dry extract of the second water-reducing additive is in a range from 30% to 90% of the concentration by weight of dry extract of the first water-reducing additive.

17. The method according to claim 15, wherein the concentration by weight of dry extract of the second water-reducing additive is in a range from 40% to 90% of the concentration by weight of dry extract of the first water-reducing additive.

18. The method according to claim 15, wherein the first water-reducing additive corresponds to the formula: 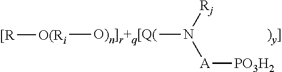
in which:
R is a hydrogen atom or a monovalent hydrocarbon group with 1 to 18 carbon atoms and optionally one or more hetero atoms;
the Rᵢ are similar or different and represent an alkylene for example ethylene, propylene, amylene, octylene or cyclohexene or an arylene, for example styrene or methylstyrene, the Rᵢ optionally comprising one or more hetero atoms;
Q is a hydrocarbon group with 2 to 18 carbon atoms and optionally one or more hetero atoms;
A is an alkylidene group with 1 to 5 carbon atoms;
the are similar or different and may be selected from:
the A-PO₃H₂ group, A having the aforesaid meaning;
an alkyl group with 1 to 18 carbon atoms and being able to carry [R—O(Rᵢ—O)ₙ] groups, R and Rᵢ having the aforesaid meanings;
and the group: 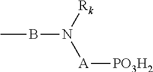
Rₖ designating a group like Rj chosen among:
the A-PO₃H₂ group, A having the aforesaid meaning; and
an alkyl group with 1 to 18 carbon atoms and being able to carry [R—O(Rᵢ—O)ₙ] groups, R and Rᵢ having the aforesaid meanings;
B designating an alkylene group with 2 to 18 carbon atoms;
“n” is a number greater than or equal to 0;
“r” is the sum of the [R—O(Rᵢ—O)ₙ] groups carried by all the Rⱼ;
“q” is the number of [R—O(Rᵢ—O)ₙ] groups carried by Q;
the sum “r+q” is from 1 to 10;
“y” is an integer from 1 to 3;
Q, N and the can form together one or more cycles, this or these cycles further being able to contain one or more other hetero atoms.

19. The method according to claim 15, wherein the first water-reducing additive corresponds to the formula: 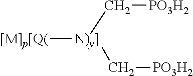
in which:
M is a linear or branched hydrocarbon group optionally comprising one or more hetero atoms;
Q is a hydrocarbon group with 2 to 18 carbon atoms and optionally one or more hetero atoms;
“p” is the number of [M] groups carried by Q, p being from 1 to 10; and
“y” is an integer from 1 to 3.

20. The method according to claim 15, wherein the concentration of the second water-reducing additive relative to the first water-reducing additive is such that a dosage of a mixture of said first and second water-reducing additives in said hydraulic composition to obtain an initial spread or slump is less than a dosage of only said first water-reducing additive in said hydraulic composition that is used to obtain said initial spread or slump.

21. The method according to claim 20, wherein a setting start time of said hydraulic composition is less than 50% of that obtained with said dosage of only said first water-reducing additive in said hydraulic composition.

22. The method according to claim 20, wherein said dosage of the mixture is less than 50% of said dosage of only said first water-reducing additive.
